(19) United States
(12) Patent Application Publication
(10) Pub. No.: US 2019/0331205 A1
(43) Pub. Date: Oct. 31, 2019

(54) HYDRAULIC CONTROL UNIT WITH ADDITIONAL OIL SUPPLY AND REMOVAL FOR A TORQUE CONVERTER OF A VEHICLE

(71) Applicant: ZF Friedrichshafen AG, Friedrichshafen (DE)

(72) Inventors: Georg EGE, Kressbronn am Bodensee (DE); Horst LEICHSENRING, Hohentengen (DE)

(21) Appl. No.: 16/074,196

(22) PCT Filed: Jan. 16, 2017
(86) PCT No.: PCT/EP2017/050799

§ 371 Date: Jul. 31, 2018

(30) Foreign Application Priority Data
Feb. 11, 2016 (DE) 10 2016 202 092.7

(51) Int. Cl. F16H 45/02; F16H 61/14; F16H 57/04; F16D 48/02

(52) U.S. Cl. CPC F16H 45/02; F16H 61/14; F16H 2045/0215; F16D 25/14; F16H 57/0412

(57) ABSTRACT

A hydraulic control unit for a torque converter and/or a converter bridging clutch, having a primary supply path via which a hydraulic fluid can be supplied by a pump to the torque converter. A primary discharge path by way of which the hydraulic fluid can be discharged from the torque converter and delivered to a cooler for cooling. A first converter pressure valve is arranged in the primary supply path for controlling a converter inlet pressure and/or a primary inlet volume flow of the hydraulic fluid. The hydraulic control unit has a secondary supply path by which, in addition to the primary supply path, additional hydraulic fluid can be supplied by the pump to the torque converter. A supply valve is arranged in the secondary supply path and controls a secondary inlet volume flow of hydraulic fluid which is additional to the primary inlet volume flow of hydraulic fluid.

This application is a National Stage completion of PCT/EP2017/050799 filed Jan. 16, 2017, which claims priority from German patent application serial no. 10 2016 202 092.7 filed Feb. 11, 2016.

### FIELD OF THE INVENTION

The present invention relates to a hydraulic control unit for a torque converter and/or a converter bridging clutch.

### BACKGROUND OF THE INVENTION

From DE 10 2006 006 179 A1 a device is known, for operating a hydrodynamic torque converter and a converter bridging clutch of a transmission device that corresponds thereto. In this, a system pressure is applied by way of a control line to a supply control tongue of a converter pressure valve. This is connected to the inlet side of the torque converter by way of a control line of a control system and a hydraulic line of a hydraulic control system. By means of the converter pressure valve, an inlet pressure of the torque converter can be regulated. The return flow of the torque converter is connected to a return flow control tongue of the converter pressure valve by way of a hydraulic line of the hydraulic control system, via a control line of the control system. Accordingly, the hydraulic fluid can be delivered to and discharged from the torque converter in a regulated manner.

Such torque converters with a converter bridging clutch have to be adapted for vehicles of different weights, such as trucks and passenger cars, since in particular due to their weight difference different converter requirements also result. Thus, for example in the case of trucks and heavy pickups, driving is carried out much more often with the converter in operation, i.e. with the converter bridging clutch open, than is the case with lighter passenger cars. The engine and converter have a higher torque capacity than those used in passenger cars. Consequently, in converters used in trucks more waste heat is generated, and this leads to heating of the converter fluid. The greater heat generation in trucks demands a large enough cooling oil volume flow in order to prevent overheating of the torque converter. Consequently the lines and/or valves in truck converters have to be made larger than those for passenger car converters. Thus, the inexpensively mass-produced passenger car converters cannot be used for vehicles having very high torque capacities.

### SUMMARY OF THE INVENTION

The purpose of the present invention is therefore to provide a hydraulic control unit which can be adapted inexpensively for operation in vehicles with varying high torque capacities.

A hydraulic control unit for a torque converter and/or a converter bridging clutch is proposed. This comprises a primary supply path by way of which a hydraulic fluid can be delivered by a pump provided for this purpose to the torque converter provided for this purpose. Besides the primary supply path, the hydraulic control unit also comprises a primary discharge path. By way of this the hydraulic fluid can be discharged from the torque converter provided for the purpose and can be delivered to a cooler provided for the purpose. The term “path” is understood to mean a system of lines by way of which the hydraulic fluid can in particular be delivered from a hydraulic reservoir to the torque converter or discharged again from the torque converter, in particular back into the hydraulic reservoir. In addition, the hydraulic control unit comprises at least a first converter pressure valve arranged in the primary supply path. By means of this first converter pressure valve a converter inlet pressure and/or a primary inlet volume flow of the hydraulic fluid can be controlled. Accordingly, by means of the first converter pressure valve the working pressure and/or the cooling oil volume flow of the torque converter can be controlled.

Furthermore, the hydraulic control unit comprises a secondary supply path by way of which, in addition to the primary supply path, more hydraulic fluid can be delivered by the pump to the torque converter. Consequently the torque converter is supplied via the primary supply path with hydraulic fluid to the level of a primary inlet volume flow and, in addition, via the secondary supply path, with hydraulic fluid to the level of a secondary inlet volume flow. To be able to control this additional, secondary inlet volume flow of hydraulic fluid, the hydraulic control unit comprises a supply valve. The supply valve is arranged in the secondary supply path. By means of it, the secondary inlet volume flow of hydraulic fluid additional to the primary volume flow can be controlled.

Thus, with the secondary supply path and the supply valve, the cooling oil volume flow of the converter, compared with a converter having only a primary supply path, can be increased without having to change the primary components, in particular of the primary supply path, of the primary discharge path, and/or of the first converter pressure valve. Advantageously, for example, a hydraulic control unit designed for passenger cars can also be used for vehicles with engines and converters that have a much greater torque capacity compared with passenger cars. The primary components designed for use in a passenger car, which include in particular the primary supply path, the primary discharge path and/or the first converter pressure valve, can therefore be quickly and inexpensively supplemented by the secondary components, in particular including the secondary supply path and the supply valve, in order for example to be used in a truck or a heavy pickup. This achieves a substantial cost advantage since the mass-produced passenger car components—in particular a hydraulic control unit which preferably comprises at least the first converter pressure valve, and/or the primary control system—can also be used in the truck context by virtue of being supplemented by the secondary supply path and the supply valve. In order to be able to use the inexpensively mass-produced hydraulic control units and primary control systems designed for small vehicles such as passenger cars, in large and heavy vehicles as well, these only have to be supplemented by the secondary components. For this the flow cross-section or aperture cross-section of the supply valve can be matched optimally to the particular size of the torque converter used. By virtue of this method a suitable, small mass-produced passenger car control unit can be adapted for utility vehicle transmissions produced in smaller numbers. Thereby, the cost advantages of mass-production can also be taken advantage of in small-scale production.

It is advantageous for the hydraulic control unit to comprise an aperture in the secondary supply path for determining the maximum secondary inlet volume flow. The aperture is preferably connected upstream from the supply valve relative to the flow direction of the hydraulic fluid. In order to determine the maximum additional secondary inlet volume flow or additional cooling oil volume flow, only the aperture cross-section then has to be adapted. Consequently, the hydraulic control unit can be adapted very quickly and inexpensively to various operating environments that demand different cooling oil volume flows.

For this additional, secondary inlet volume flow to be able to be discharged again without large line losses, it is advantageous for the hydraulic control unit to comprise a secondary discharge path. By way of this, in addition to the primary discharge path more hydraulic fluid can be discharged from the torque converter. By virtue of this additional integrated discharge function the efficiency of the torque converter can be increased.

In this connection it is also advantageous for the hydraulic control unit to comprise a discharge valve arranged in the secondary discharge path. Furthermore, this is advantageously designed such that by means of it, a secondary discharge volume flow additional to a primary discharge volume flow of the primary discharge path can be controlled. Thus, by means of the discharge valve it can be ensured that sufficient hydraulic fluid remains in the torque converter for the torque converter to operate properly, and at the same time sufficient hydraulic fluid is discharged from it in particular to keep the line losses as low as possible.

It is advantageous for the hydraulic control unit to be designed such that the supply valve and/or the discharge valve can be controlled in a manner that depends on the first converter pressure valve. Thereby, the hydraulic control unit does not need any additional pressure regulator, so that it can be made inexpensively. Thus, the direct control of the first converter pressure valve by the control unit enables the supply valve and/or the discharge valve to be controlled indirectly as a function of a parameter influenced by the first converter pressure valve, in particular a pressure variation.

In this connection it is particularly advantageous for a secondary control pressure of the supply valve and/or the discharge valve to be able to be controlled as a function of the converter inlet pressure, itself controlled by the first converter pressure valve. Thus, in control technology terms the supply valve and/or the discharge valve are subordinate to the first converter pressure valve. Accordingly, when the first converter pressure valve is regulated the electronic control of the first converter pressure valve automatically also indirectly controls the supply valve and/or the discharge valve. In doing this the electronic control system takes into account both the pressure change and/or the volume flow change when the first converter pressure valve is opened and/or closed, and also when the supply valve and/or the discharge valve is opened and/or closed, in order to regulate to the desired value the total supply pressure and the total cooling oil volume flow that depend on the primary path and on the secondary path.

When the converter bridging clutch is closed, the supply valve and/or the discharge valve is/are closed so that no hydraulic fluid can flow into and/or out of the torque converter. During this the supply valve and/or the discharge valve is/are preferably held in the closed position by a spring device, in particular a separate or common spring element. In order to be able to avoid opening of the supply valve and/or the discharge valve at the torque converter in the event of pressure fluctuations, it is advantageous for the supply valve and/or the discharge valve to be able to be locked in their closed position by a locking pressure in addition to the spring force. In that way, unintentional opening of the supply valve and/or the discharge valve can be avoided, especially when the converter bridging clutch is closed.

It is advantageous for the hydraulic control unit to comprise a converter clutch valve for controlling a clutch supply pressure of the converter bridging clutch. With increasing clutch supply pressure, the converter bridging clutch can close. In that connection it is particularly advantageous for the locking pressure for holding the supply valve and/or the discharge valve in the closed position to be controlled as a function of the clutch supply pressure. In that case the locking pressure increases with increasing clutch supply pressure in such manner that when the converter bridging clutch is closed, the locking pressure reaches a maximum for holding the supply valve and/or the discharge valve in the closed position.

It is advantageous for the secondary supply path to comprise a first secondary supply line in which the aperture for determining the maximum secondary supply volume flow is arranged. The first secondary supply line is in that case preferably connected to a first switching tongue of the supply valve in the flow direction of the hydraulic fluid coming from the pump provided for the purpose. Thereby, the hydraulic fluid delivered by the pump can be conveyed to the supply valve via the aperture with a volume flow limited to a maximum value by the first switching tongue.

Furthermore, it is advantageous for the secondary supply path to comprise a second secondary supply line. This is preferably connected, at its upstream end in relation to the flow direction, to a second switching tongue of the supply valve. In addition, at its end downstream in relation to the flow direction, the second supply line merges with the primary supply path, particularly at its point of connection. Thus, when the supply line is open additional hydraulic fluid can be supplied to the torque converter by way of the second secondary supply line.

In an advantageous further development of the invention the secondary discharge path comprises a first secondary discharge line. This is connected to a first switching tongue of the discharge valve in the flow direction coming from the torque converter provided for the purpose. Thereby, the hydraulic fluid can pass from the torque converter via the secondary discharge line to the discharge valve.

Moreover, it is advantageous for the secondary discharge path to comprise a second secondary discharge line. At its upstream end in relation to the flow direction this is preferably connected to a second switching tongue of the discharge valve. At its downstream end in relation to the flow direction the second secondary discharge line merges with the primary discharge path, in particular at a connection point. In that way the hydraulic fluid can be supplied from the discharge valve to the cooler provided for the purpose.

It is advantageous for the hydraulic control unit, in addition to a hydraulic control device, to comprise a second converter pressure valve. Preferably, the supply valve and the discharge valve are comprised in this second converter pressure valve or formed thereby. Thus, the supply valve and the discharge valve form a valve unit. Consequently, the supply valve and the discharge valve have a common valve slide. Thus, both the supply valve and the discharge valve can be shifted between a through-flow position and a closed position, depending on the position of the common valve slide. The valve slide is designed such that when it is displaced, the supply valve and the discharge valve can both be shifted to the closed position or the through-flow position.

The common valve slide of the second converter pressure valve can preferably be moved by means of the common secondary control pressure and/or can be locked by means of the common locking pressure. The switching tongues of the supply valve and the discharge valve and the varying diameter range of the common valve slide are designed such that in a first end position of the valve slide both the supply valve and the discharge valve are open, and in a second end position both valves are closed. In this way it can be ensured that during an additional supply of fluid via the secondary supply path, at the same time hydraulic fluid can also be discharged via the secondary discharge path.

It is advantageous for the second converter pressure valve to be arranged in or on an intermediate plate of a transmission. It is also advantageous for the second converter pressure valve to be arranged in or on a hydraulic control device, or in a transmission housing. Furthermore, it is advantageous for the second converter pressure valve to be arranged close to the pump.

It is advantageous for the primary supply path to comprise a primary supply line leading from the first converter pressure valve to the torque converter provided for the purpose. In order to be able to control both the supply valve and the discharge valve by means of a common secondary control pressure that depends on the controlled converter inlet pressure, it is advantageous for the hydraulic control unit to comprise a control pressure line. In this case the control pressure line preferably branches off the primary supply line. At its other end the control pressure line is preferably connected to a common control switching tongue of the second converter pressure valve. Consequently, the secondary control pressure of the second converter pressure valve increases with increasing converter inlet pressure, whereby the common valve slide is displaced from the closed position to the through-flow position. The second converter pressure valve is thereby regulated in a manner that depends on the first converter pressure valve, in particular the regulated converter inlet pressure. For that reason additional control components can be omitted, so that the hydraulic control unit can be produced inexpensively.

It is also advantageous for the hydraulic control unit to comprise a clutch supply line leading from the converter clutch valve to the converter bridging clutch provided for the purpose. To lock the second converter pressure valve in its closed position, it is advantageous for the hydraulic control unit to comprise a locking pressure line. This preferably branches off from the clutch supply line and at its other end is connected to a locking switching tongue of the second converter pressure valve, in particular a common one. Thus, with increasing clutch inlet pressure the locking pressure of the second converter pressure valve also increases by way of the locking pressure line. In this way a very inexpensive locking system for the reliable locking of the second converter pressure valve or the common valve slide in its closed position can be provided.

It is advantageous for the hydraulic control unit to comprise a hydraulic control device. This is preferably a hydraulic control device for a passenger car. The hydraulic control device comprises in particular an electronic control system, the first converter pressure valve and/or the converter clutch valve. Furthermore, the hydraulic control device is preferably designed such that by means of it, the second converter pressure valve can be controlled indirectly, in particular by the converter inlet pressure controlled by the hydraulic control device.

It is advantageous for the hydraulic control unit to comprise the cooler, the pump and/or the hydraulic reservoir.

Also proposed is a starter device with a torque converter, a converter bridging clutch and a hydraulic control unit. The hydraulic control unit is made in accordance with the above description, wherein the characteristics can be present in isolation or in any desired combination.

### BRIEF DESCRIPTION OF THE DRAWINGS

Below, the invention is explained in greater detail with reference to drawings, which show:

FIG. 1: A very schematically represented starting device of a drive-train of a vehicle, and

FIG. 2: A view from above, of an intermediate plate of the drive-train.

### DETAILED DESCRIPTION OF THE PREFERRED EMBODIMENTS

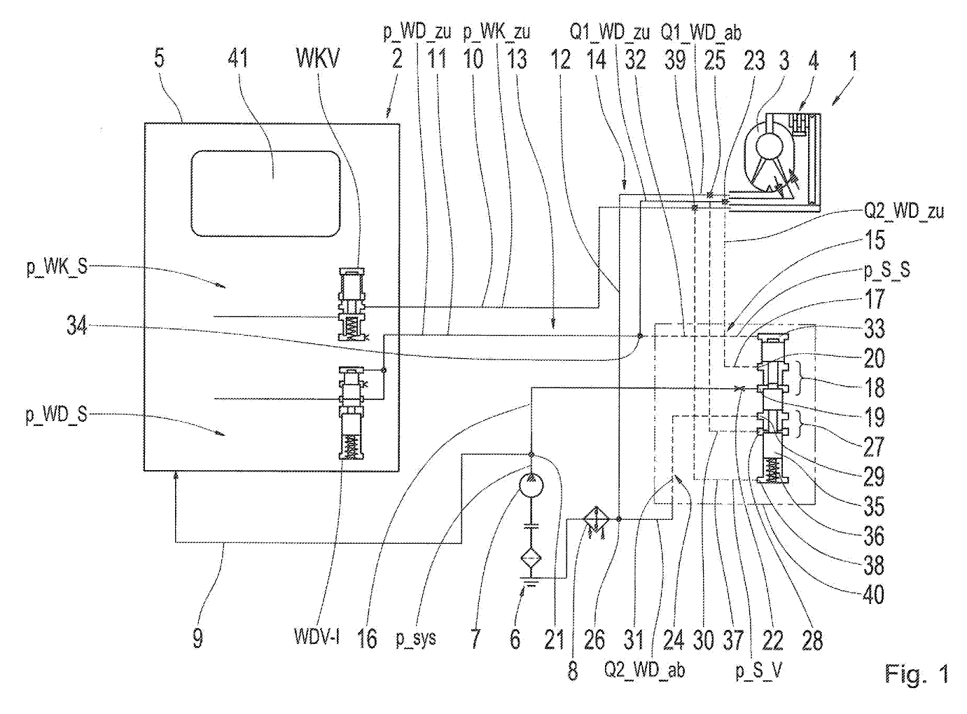

FIG. 1 shows a starting device 1 represented very schematically. The starting device 1 comprises a hydrodynamic torque converter 3 with a controlled converter bridging clutch 4. In a known manner, during converter operation, i.e. in particular when starting off under heavy load, crawling, maneuvering and/or when driving along winding roads or uphill, the converter bridging clutch 4 is opened. Consequently, there is no mechanical coupling between a turbine wheel and a pump wheel of the torque converter. Only when the rotational speed of a turbine wheel (not shown in detail here) has essentially approached that of a pump wheel of the torque converter, is the converter bridging clutch 4 closed in order to improve the efficiency. When the converter bridging clutch 4 is closed, the turbine wheel is coupled to the pump wheel in a rotationally fixed manner.

To be able to control that process adequately, the starting device 1 comprises a hydraulic control unit 2. By means of the hydraulic control unit 2 a clutch inlet pressure p_WK_zu for opening and closing the converter bridging clutch 4 can be regulated. In addition, by means of the hydraulic control unit 2, in relation to the torque converter 3 a converter inlet pressure p_WD_zu and an inlet volume flow Q1_WD_zu, Q2_WD_zu and a discharge volume flow Q1_WD_ab, Q2_WD_ab can be regulated. For this the hydraulic control unit 2 comprises in essence a converter clutch valve WKV and a first converter pressure valve WDV-I. These are preferably parts of a hydraulic control device 5, which can be mass-produced and whose hardware components are designed for small torque capacities. By means of the converter clutch valve WKV the clutch inlet pressure p_WK_zu can be regulated in such manner that when the converter inlet pressure p_WD_zu is high enough the converter bridging clutch 4 is closed, whereas when the converter inlet pressure p_WD_zu is low it is opened again.

In the first phase of converter operation, for example when starting off under heavy load, the first converter pressure valve WDV-I is essentially fully open, so that a higher converter inlet pressure p_WD_zu and a larger inlet volume flow Q1_WD_zu are made available to the torque converter 3. During converter operation the hydraulic fluid is very strongly heated, so that a sufficiently high cooling oil volume flow has to be provided. As soon as the rotational speed of the turbine wheel (not illustrated in detail here) has become equal to the rotational speed of the pump wheel of the torque converter 3, the first converter pressure valve WDV-I closes and the converter clutch valve WKV opens, so that the turbine wheel and the pump wheel of the torque converter 3 are connected rotationally fixed to one another by means of the converter bridging clutch 4.

As already mentioned earlier, the hydraulic control unit 2 preferably comprises the hydraulic control device 5 this being in particular a mass-produced hydraulic control device, in particular a control device for passenger cars. The converter clutch valve WKV and/or the first converter pressure valve WDV-I are parts of the hydraulic control device 5.

The starting device 1 also comprises a hydraulic reservoir 6, a pump 7 and/or a cooler 8. From the hydraulic reservoir 6 the pump 7 delivers the hydraulic fluid, which after the pump 7 has a system pressure p_sys. The pump 7 is hydraulically connected via a control device supply line 9 to the hydraulic control device 5, in particular to the converter clutch valve WKV and/or the first converter pressure valve WDV-I. Thus, the system pressure p_sys is applied both to the converter clutch valve WKV and to the first converter pressure valve WDV-I, which pressure is regulated by the valve WKV, WDV-I concerned to the clutch inlet pressure p_WK_zu and to the converter inlet pressure p_WD_zu. The converter clutch valve WKV can be controlled by a primary clutch control pressure p_WK_S. Depending on the control pressure p_WK_S, p_WD_S concerned, the respectively present spring-loaded valve slide (not described in greater detail here) of the converter pressure valve WDV-I and the converter clutch valve WKV can be moved between a closed position and a through-flow position. The converter control pressure p_WD_S and/or the clutch control pressure p_WK_S can be directly controlled and/or regulated by an electronic control unit 41 of the hydraulic control device 5.

The converter clutch valve WKV is connected to the converter bridging clutch 4 by way of a clutch supply line 10. The first converter pressure valve WDV-I is hydraulically connected to the torque converter 3 by a primary supply line 11. Furthermore, the hydraulic control unit 2 comprises a primary discharge line 12 that leads from the torque converter 3 toward the cooler 8.

According to the above description the hydraulic control unit 2 for a torque converter 3 therefore comprises a primary supply path 13 and a primary discharge path 14. Here, the term “path” is understood to mean a system of lines by way of which the hydraulic fluid can be supplied to or discharged from the torque converter 3 at a particular pressure and/or with a particular volume flow.

According to the example embodiment represented in FIG. 1, the primary supply path 13 includes the control device supply line 9 and the primary supply line 11. Between the two of them is arranged the first converter pressure valve WDV-I, in order to be able to regulate the system pressure p_sys to the converter inlet pressure p_WD_zu. In addition, by means of the first converter pressure valve WDV-I a primary inlet volume flow Q1_WD_zu can be regulated.

By way of the primary discharge path 14 the hydraulic fluid can be discharged again from the torque converter 3 into the hydraulic reservoir 6. According to the present example embodiment the primary discharge path 14 comprises the primary discharge line 12, which runs from the torque converter 3 to the cooler 8. In the cooler 8 the hydraulic fluid heated in the torque converter 3 can be cooled and then passed back into the hydraulic reservoir 6 by way of a further line. Via the primary discharge path 14 the hydraulic fluid can be discharged from the torque converter 3 toward the cooler 8 with a primary discharge volume flow Q1_WD_ab.

Thus, according to the above description, via the primary supply path 13 the hydraulic fluid can be supplied from the hydraulic reservoir 6 with a converter inlet pressure p_WD_zu and a primary inlet volume flow Q1_WD_zu that can be regulated by the first converter pressure valve WDV-I. Furthermore, the hydraulic fluid supplied to the torque converter 3 can be discharged again via the primary discharge path 14 with a primary discharge volume flow Q1_WD_ab and passed on to the cooler 8. The hydraulic fluid cooled down in the cooler 8 can then be passed back into the hydraulic reservoir 6.

In order to be able to control the primary discharge volume flow Q1_WD_ab, a valve (not shown in this case) can be arranged in the primary discharge path 14, which valve can be controlled by the hydraulic control device 5. Preferably, this valve can be controlled by the converter control pressure p_WD_S of the first converter pressure valve WDV-I. In a preferred example embodiment this valve, which controls the primary discharge volume flow Q1_WD_ab, is integrated in the first converter pressure valve WDV-I. Accordingly, by means of the converter control pressure p_WD_S of the first converter pressure valve WDV-I both the primary supply volume flow Q1_WD_zu and also the primary discharge volume flow Q1_WD_ab can be controlled. The first converter pressure valve WDV-I would accordingly also be arranged in the primary discharge path 14 in order to be able to regulate the primary discharge volume flow Q1_WD_ab and/or a converter discharge pressure.

The maximum primary inlet volume flow Q1_WD_zu is limited by the primary supply path 13. Consequently, a hydraulic control device 5 designed for low torque capacities cannot be used for vehicles which have a higher torque capacity compared to them. Thus, mass-produced passenger car control devices cannot be used in trucks or, for example, heavy pickups, since the maximum coolant volume flow available is not sufficient to be able to prevent overheating of the torque converter 3.

Because of this, in the example embodiment illustrated in FIG. 1 the hydraulic control unit 2 comprises a secondary supply path 15. By way of this, in addition to the primary supply path 13 further hydraulic fluid can be supplied by the pump, 7 from the hydraulic reservoir 6 to the torque converter 3. Thus, the hydraulic fluid can be supplied to the torque converter 3 by way of the primary supply path 13 with a primary inlet volume flow Q1_WD_zu and by way of the secondary supply path 15 with a secondary inlet volume flow Q2_WD_zu.

In essence, the secondary supply path 15 comprises a first secondary supply line 16 and a second secondary supply line 17. In order to be able to control the secondary inlet volume flow Q2_WD_zu, the hydraulic control unit 2 comprises a supply valve 18 which is arranged in the secondary supply path 15. According to the example embodiment represented in FIG. 1, the supply valve 18 is arranged between the first and second supply lines 16, 17. The supply valve 18 has two switching tongues 19, 20. The first switching tongue 19 of the supply valve 18 is connected to the first secondary supply line 16. At its end remote from the supply valve 18, the first secondary supply line 16 is connected to a branching point 21. By virtue of the branching point 21 a pump-side line is divided between the primary supply path 13 and the secondary supply path 15 or, in particular, into the control device supply line 9 and the first secondary supply line 16. Thus, both in the control device supply line 9 and also in the first secondary supply line 16 the system pressure p_sys prevails.

The hydraulic control unit 2 also comprises an aperture 22 connected upstream from the supply valve 18. Thus, by means of the aperture 22 the secondary inlet volume flow Q2_WD_zu can be limited to a maximum value. In order to be able to adapt the maximum secondary inlet volume flow Q2_WD_zu quickly and inexpensively for different application cases, it is therefore only necessary to replace the aperture 22 or adjust its aperture diameter. In the example embodiment shown in FIG. 1, the aperture is therefore arranged upstream from the supply valve 18 in the first secondary supply line 16.

The second secondary supply line 17 is connected at one end to the second switching tongue 20 of the supply valve 18. At its end directed toward the torque converter 3, the second secondary supply line 17 merges with the primary supply line 11 at a first connection point 23. The first connection point 23 thus brings together the primary supply path 13 and the secondary supply path 15. Thus, the first connection point combines the primary inlet volume flow Q1_WD-zu and the secondary inlet volume flow Q2_WD_zu, so that the torque converter 3 is supplied with a correspondingly larger cooling oil volume flow.

In order to be able to discharge the inlet volume flow additionally supplied to the torque converter 3 via the primary supply path 13 without large line losses, the hydraulic control unit 2 further comprises a secondary discharge path 24. By way of this secondary discharge path 24, in addition to the primary discharge path 14 more hydraulic fluid can be discharged from the torque converter 3 and passed on to the cooler 8. Accordingly, via the secondary discharge path 24 the hydraulic fluid can be discharged from the torque converter 3 with a secondary discharge volume flow Q2_WD_ab.

On the side of the torque converter 3, the hydraulic control unit 2 has a second branching point 25, by which the line system in the primary discharge path 14 and the secondary discharge path 24 is divided. At a second connection point 26, the primary discharge path 14 and the secondary discharge path 24 are brought together.

In order to be able to control the additional secondary discharge volume flow Q2_WD_ab, the hydraulic control unit 2 has a discharge valve 27. The discharge valve 27 is arranged in the secondary discharge path 24. Analogously to the supply valve 18, the discharge valve 27 also has two switching tongues 28, 29. The first switching tongue 28 of the discharge valve 27 is connected to a first secondary discharge line 30. Thus, the first secondary discharge line 30 runs from the second branching point 25 to the first switching tongue 28 of the discharge valve 27. The second switching tongue 29 of the discharge valve 27 is connected to a second secondary discharge line 31. The second secondary discharge line 31 and the primary discharge line 12 are brought together at a second connection point 26. Thus, via the second connection point 26 the hydraulic fluid flows carried by the primary discharge path 14 and by the secondary discharge path 24 are together passed into the cooler 8.

According to the above description the hydraulic control unit 2 therefore comprises a secondary supply path 15 which is redundant and/or parallel relative to the primary supply path 13, so that the secondary inlet volume flow Q2_WD_zu delivered by the secondary supply path 15 can be controlled by means of the supply valve 18. In addition, the hydraulic control unit 2 comprises a secondary discharge path 24 which runs parallel and/or is redundant relative to the primary discharge path 14, so that the additionally discharged secondary discharge volume flow Q2_WD_ab can be controlled by the discharge valve 27. Thus, advantageously, the hydraulic control unit 2 can be adapted quickly and inexpensively by adapting the components of the secondary unit for use in vehicles with higher torque capacities.

According to the example embodiment represented in FIG. 1, the supply valve 18 and/or the discharge valve 27 is/are controlled not directly by the hydraulic control device 5, but indirectly as a function of the converter inlet pressure p_WD_zu regulated by it. Thus, as the converter inlet pressure p_WD_zu increases, the supply valve 18 and/or the discharge valve 27 are switched from a closed position to a through-flow position. For this, the hydraulic control unit 2 has a control pressure line 32. The control pressure line 32 connects a control switching tongue 33 of the supply valve 18 and/or of the discharge valve 27 to the primary supply line 11. For this, the primary supply line 11 has a branching point 34 in the area of which the control pressure line 32 is connected to the primary supply line 11. When the first converter pressure valve WDV-I is open, the converter inlet pressure p_WD_zu increases and at the same time so does a secondary control pressure p_S_S of the supply valve 18 and/or the discharge valve 27 applied at the control switching tongue 33.

In order to be able to produce the hydraulic control unit 2 as inexpensively as possible, in the present example embodiment the supply valve 18 and the discharge valve 27 have a common control pressure line 32. Furthermore, the hydraulic control unit 2 in this example embodiment has a second converter pressure valve WDV-II, which comprises the supply valve 18 and the discharge valve 27. Thus, the supply valve 18 and the discharge valve 27 have a common valve slide 35. The common valve slide 35 has associated with the supply valve 18 a tapering first diameter region and associated with the discharge valve 27 a tapering second diameter region. By means of a spring element 36 the valve slide 35 is held in its closed position under spring load. The control pressure line 32 and the control switching tongue 33 of the second converter pressure valve WDV-II thus provide a common secondary control pressure p_S_S, for both the supply valve 18 and the discharge valve 27. This acts on the end of the valve slide 35 remote from the spring element 36.

Thus, as the secondary control pressure p_S_S increases, to open the second converter pressure valve WDV-II or to open the supply valve 18 and the discharge valve 27 the common valve slide 35 is displaced against the spring force of the spring element 26 out of its closed position into a through-flow position. When the valve slide 35 is in the through-flow position, additional hydraulic fluid can be supplied to the torque converter 3 by way of the secondary supply path 15 via the second converter pressure valve WDV-II and additional hydraulic fluid can be discharged by way of the secondary discharge path 24. The supply valve 18 and/or the discharge valve 27, or in particular the second converter pressure valve WDV-II comprising the two of them, are thus not controlled directly by the electronic control system 41. Instead, they are controlled indirectly by the converter inlet pressure p_WD_zu, itself controlled by the first converter pressure valve WDV-I by way of the control pressure line 32 and the common control switching tongue 33.

When the converter bridging clutch 4 is closed, the second converter pressure valve WDV-II is in its closed position. To be able to avoid an unintentional opening of the second converter pressure valve WSDV-II, the latter can be locked in a manner that depends on the clutch inlet pressure p_WK_zu. For this, the hydraulic control unit 2 comprises a locking pressure line 37. This is connected to a locking switching tongue 38 of the second converter pressure valve WDV-II. The locking switching tongue 38 and the control switching tongue 33 are arranged at opposite ends of the second converter pressure valve WDV-II. By way of a second branching point 39 the locking pressure line 37 is connected to the clutch supply line 10. Thus, when the converter clutch valve WKV is open, the clutch inlet pressure p_WK_zu and a secondary locking pressure p_S_V of the second converter pressure valve WDV-II both increase. In addition to the spring force of the spring element 36 this secondary locking pressure p_S_V pushes the valve slide 35 to its closed position. In this way, an unintentional opening of the second converter pressure valve WDV-II due to pressure fluctuations, especially in the control pressure line 32, can be avoided.

The electronic control system 41 is designed in such manner that when controlling the first converter pressure valve WDV-I it takes into account both the pressure variation in the primary supply path 13 and also the pressure variation in the secondary supply path—resulting from the indirect control of the second converter pressure valve WDV-II—in order to be able to produce the desired inlet pressure of the torque converter 3. The same applies for the discharge pressure of the torque converter.

Furthermore, the electronic control system 41 is designed in such manner that when controlling the first converter pressure valve WDV-I it takes into account both the volume flow variation in the primary supply path 13 and also the volume flow variation in the secondary supply path—resulting from the indirect control of the second converter pressure valve WDV-II—in order to be able to produce the desired inlet volume flow of the torque converter 3. The same applies for the discharge volume flow of the torque converter.

Alternatively to the example embodiment shown in FIG. 1, the supply valve 18 and the discharge valve 27 can also not be combined in the second converter pressure valve WDV-II, but can be made as two separate valves. In that case both the supply valve 18 and also the discharge valve 27 would comprise separate control pressure lines 32 and separate locking pressure lines 37 with a respectively separate control switching tongue 33 and/or locking switching tongue 38.

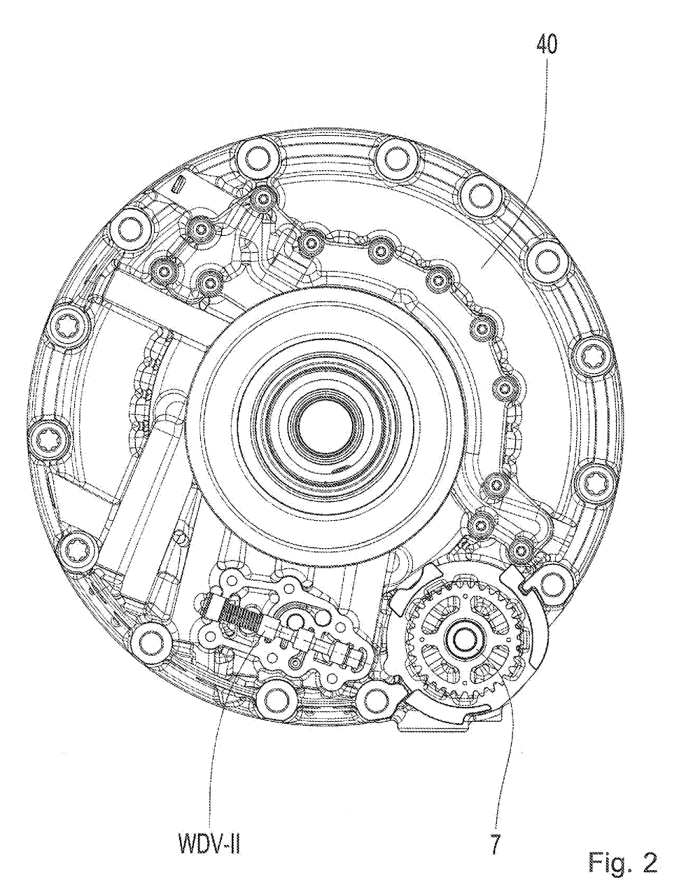

FIG. 2 shows a view from above, of an intermediate plate 40 of the starting device. The second converter pressure valve WDV-II is in this case arranged in the intermediate plate 40. Moreover, the second converter pressure valve WDV-II is arranged in the area of the pump 7.

The present invention is not limited to the example embodiments illustrated and described. Deviations within the scope of the claims are possible, as also are combinations of features, even if these are illustrated and described in different example embodiments.

Indexes

| | |
|---|---|
| 1 | Starting device |
| 2 | Hydraulic control unit |
| 3 | Torque converter |
| 4 | Converter bridging clutch |
| 5 | Hydraulic control device |
| 6 | Hydraulic reservoir |
| 7 | Pump |
| 8 | Cooler |
| 9 | Control device supply line |
| 10 | Clutch supply line |
| 11 | Primary supply line |
| 12 | Primary discharge line |
| 13 | Primary supply path |
| 14 | Primary discharge path |
| 15 | Secondary supply path |
| 16 | First secondary supply line |
| 17 | Second secondary supply line |
| 18 | Supply valve |
| 19 | First switching tongue of the supply valve |
| 20 | Second switching tongue of the supply valve |
| 21 | First branching point |
| 22 | Aperture |
| 23 | First connection point |
| 24 | Secondary discharge path |
| 25 | Second branching point |
| 26 | Second connection point |
| 27 | Discharge valve |
| 28 | First switching tongue of the discharge valve |
| 29 | Second switching tongue of the discharge valve |
| 30 | First secondary discharge line |
| 31 | Second secondary discharge line |
| 32 | Control pressure line |
| 33 | Control switching tongue |
| 34 | First branching-off point |
| 35 | Common valve slide |
| 36 | Spring element |
| 37 | Locking pressure line |
| 38 | Locking switching tongue |
| 39 | Second branching-off point |
| 40 | Intermediate plate |
| 41 | Electronic control system |
| WKV | Converter clutch valve |
| WDV-I | First converter pressure valve |
| WDV-II | Second converter pressure valve |
| p_sys | System pressure |
| p_WK_zu | Clutch inlet pressure |
| p_WD_zu | Converter inlet pressure |
| p_WK_S | Clutch control pressure |
| p_WD_S | Converter control pressure |
| p_S_S | Secondary control pressure |
| p_S_V | Secondary locking pressure |
| Q1_WD_zu | Primary inlet volume flow |
| Q2_WD_zu | Secondary inlet volume flow |
| Q1_WD_ab | Primary discharge volume flow |
| Q2_WD_ab | Secondary discharge volume flow |

1-16. (canceled)

17. A hydraulic control unit for at least one of a torque converter (3) and a converter bridging clutch (4), comprising:
a primary supply path (13) by way of which hydraulic fluid is supplied by a pump (7), provided for this purpose, to the torque converter (3) provided for this purpose,
a primary discharge path (14) by way of which the hydraulic fluid is discharged from the torque converter (3) and delivered to a cooler (8) provided for this purpose,
a first converter pressure valve (WDV-I) being arranged along the primary supply path (13) by which at least one of a converter inlet pressure (p_WD_zu) and a primary inlet volume flow (Q1_WD_zu) of the hydraulic fluid being controllable,
a secondary supply path (15), by way of which additional hydraulic fluid, in addition to the primary supply path (13), being supplied by the pump (7) to the torque converter (3), and
a supply valve (18) being arranged along the secondary supply path (15) by which a secondary inlet volume flow (Q2_WD_zu) of hydraulic fluid, in addition to the primary inlet volume flow (Q1_WD_zu), being controllable.

18. The hydraulic control unit according to claim 17, wherein the hydraulic control unit (2) comprises an aperture (22) arranged along the secondary supply path (15) for determining a maximum secondary inlet volume flow (Q2_WD_zu), and the aperture is arranged upstream, in a flow direction, from the supply valve (18).

19. The hydraulic control unit according to claim 17, wherein the hydraulic control unit (2) comprises a secondary discharge path (24) by way of which, in addition to the primary discharge path (14), additional hydraulic fluid is dischargable from the torque converter (3) and passed on to the cooler (8).

20. The hydraulic control unit according to claim 19, wherein the hydraulic control unit (2) comprises a discharge valve (27) arranged along the secondary discharge path (24), by which a secondary discharge volume flow (Q2_WD_ab), in addition to a primary discharge volume flow (Q1_WD_ab) of the primary discharge path (14), is controllable.

21. The hydraulic control unit according to claim 17, wherein the hydraulic control unit (2) is designed such that at least one of the supply valve (18) and a discharge valve (27) is controllable as a function of the first converter pressure valve (WDV-I).

22. The hydraulic control unit according to claim 17, wherein a secondary control pressure (p_S_S) of at least one of the supply valve (18) and a discharge valve (27) is controllable as a function of the converter inlet pressure (p_WD_zu), which is controlled by the first converter pressure valve (WDV-I).

23. The hydraulic control unit according to claim 17, wherein at least one of the supply valve (18) and a discharge valve (27) are locked in a closed position by a secondary locking pressure (p_S_V).

24. The hydraulic control unit according to claim 17, wherein the hydraulic control unit (2) comprises a converter clutch valve (WKV) for controlling at least one of a clutch inlet pressure (p_WK_zu), of the converter bridging clutch (4), and a secondary locking pressure (p_S_V), of the supply valve (18), and a discharge valve (27) is controllable as a function of the clutch inlet pressure (p_WK_zu).

25. The hydraulic control unit according to claim 17, wherein the secondary supply path (15) comprises at least one of:
a first secondary supply line (16) in which at least one of the aperture (22) is arranged, and which is connected, in the flow direction coming from the pump (7) provided for this purpose, to a first switching tongue (19) of the supply valve (18), and
a second secondary supply line (17), which is connected at one end to a second switching tongue (20) of the supply valve (18) and, at an other end, merges with the primary supply path (13).

26. The hydraulic control unit according to claim 20, wherein the secondary discharge path (24) comprises at least one of:
a first secondary discharge line (30) which is connected in a flow direction coming from the torque converter (3), provided for this purpose, to a first switching tongue (28) of the discharge valve (27), and
a second secondary discharge line (31), which is connected, at one end, to a second switching tongue (29) of the discharge valve (27) and, at an other end, merges with the primary discharge path (14).

27. The hydraulic control unit according to claim 20, wherein the supply valve (18) and the discharge valve (27) are comprised in a second converter pressure valve (WDV-II), and have a common valve slide (35) which is at least one of displaceable by a secondary control pressure (p_S_S) and lockable by a secondary locking pressure (p_S_V).

28. The hydraulic control unit according to claim 17, wherein the hydraulic control unit (2) comprises a hydraulic control device (5) which comprises at least one of the first converter pressure valve (WDV-I) and the second converter pressure valve (WDV-II), and by which the second converter pressure valve (WDV-II) is indirectly controllable, by the converter inlet pressure (p_WD_zu), which is controlled by the hydraulic control device (5).

29. The hydraulic control unit according to 27, wherein the second converter pressure valve (WDV-II) is one of arranged either:
in or on an intermediate plate (40) of a transmission,
in or on the hydraulic control device (5), or
in a transmission housing.

30. The hydraulic control unit according to claim 17, wherein the primary supply path (13) comprises a primary supply line (11) leading from the first converter pressure valve (WDV-I) to the torque converter (3) provided for this purpose, from which a control pressure line (32) branches off, which at an end is connected to a control switching tongue (33) of at least one of the supply valve (18) and a discharge valve (27) of a second converter pressure valve (WDV-II) that comprises the supply valve and the discharge valve.

31. The hydraulic control unit according to claim 24, wherein the hydraulic control unit (2) comprises a clutch supply line (10) leading from the converter clutch valve (WKV) to the converter bridging clutch (4) provided for this purpose, from which a locking pressure line (37) branches off, which is connected at an end to a locking switching tongue of at least one of the supply valve (18) and the discharge valve (27) of the second converter pressure valve (WDV-II) that comprises the supply valve and the discharge valve.

32. A starting device (1) comprising:
a torque converter (3),
a converter bridging clutch (4), and
a hydraulic control unit (2) having a primary supply path (13) by way of which hydraulic fluid being supplied by a pump (7), provided for this purpose, to the torque converter (3) provided for this purpose,
a primary discharge path (14) by way of which the hydraulic fluid being discharged from the torque converter (3) and delivered to a cooler (8) provided for this purpose, and
a first converter pressure valve (WDV-I) being arranged along the primary supply path (13) and by which at least one of a converter inlet pressure (p_WD_zu) and a primary inlet volume flow (Q1_WD_zu) of the hydraulic fluid being controllable, a secondary supply path (15), by way of which, in addition to the primary supply path (13), additional hydraulic fluid being supplied by the pump (7) to the torque converter (3), with a supply valve (18) being arranged along the secondary supply path (15) by which a secondary inlet volume flow (Q2_WD_zu) of hydraulic fluid, in addition to the primary inlet volume flow (Q1_WD_zu), being controllable

33. A hydraulic control unit for at least one of a torque converter (3) and a converter bridging clutch (4), the hydraulic control unit comprising:
a primary supply path (13) via which hydraulic fluid being supplied by a pump (7) to the torque converter (3), and a primary discharge path (14) via which hydraulic fluid being discharged from the torque converter (3) and delivered to a cooler (8);
a first converter pressure valve (WDV-I) being arranged along the primary supply path (13), at least one of a converter inlet pressure (p_WD_zu) and a primary inlet volume flow (Q1_WD_zu) of the hydraulic fluid in the primary supply path being controllable by the first converter pressure valve; and
a secondary supply path (15) via which additional hydraulic fluid being supplied by the pump (7) to the torque converter (3), a supply valve (18) being arranged along the secondary supply path (15), and
the supply valve controlling a secondary inlet volume flow (Q2_WD_zu) of the additional hydraulic fluid to the torque converter, and the secondary inlet volume flow of the additional hydraulic fluid being combined with the primary inlet volume flow (Q1_WD_zu) of hydraulic fluid.
